(19) United States
(12) Patent Application Publication
(10) Pub. No.: US 2016/0012301 A1
(43) Pub. Date: Jan. 14, 2016

(54) METHOD AND DEVICE FOR RECOGNIZING NON-MOTORIZED ROAD USERS

(71) Applicant: FORD GLOBAL TECHNOLOGIES, LLC, Dearborn, MI (US)

(72) Inventors: Christoph ARNDT, Moerlen (DE); Uwe GUSSEN, Huertgenwald (DE); Frederic STEFAN, Aachen (DE); Goetz-Philipp WEGNER, Dortmund (DE)

(73) Assignee: FORD GLOBAL TECHNOLOGIES, LLC

(21) Appl. No.: 14/766,961

(22) PCT Filed: Apr. 22, 2014
(86) PCT No.: PCT/EP2014/058059

§ 371 Date: Aug. 10, 2015

(30) Foreign Application Priority Data
Apr. 22, 2013 (DE) 10 2013 207 223.6

(51) Int. Cl. G06K 9/00; B60W 50/14; G06K 9/46

(52) U.S. Cl. CPC G06K 9/00805; G06K 9/00845; G06K 9/00375; G06K 9/4604; G06K 9/4652; G06K 9/00536; B60W 50/14

(57) ABSTRACT

A method and apparatus for the automatic recognition of gestures or visual signals made by non-motorized road users (pedestrians, cyclists, traffic police, crossing guards, horse riders, etc.) in the vicinity of a motor vehicle. Images recorded by a digital camera on-board the motor vehicle are analyzed to determine whether a person is directing a traffic-related visual message at the driver of the motor vehicle. Indicators of whether the person's message is directed at the driver include the person's head orientation, body orientation, and visual direction. If the message is directed at the driver, the content of the message is determined and the driver is informed of the content.

### CROSS-REFERENCE TO RELATED APPLICATIONS

This application is the U.S. national phase of PCT Application No. PCT/EP2014/058059 filed Apr. 22, 2014, which claims priority to German Application No. 10 2013 207 223.6 filed Apr. 22, 2013, the disclosures of which are incorporated by reference in their entirety.

### TECHNICAL FIELD

The invention relates to a method for the automatic recognition of non-motorized road users in the vicinity of a traveling motor vehicle using images which are recorded by means of at least one camera fitted in or to the motor vehicle and are analyzed for further information contained therein, and a device to carry out the method.

### BACKGROUND

A method of this type is known from DE 10 2007 052 093 A1. When the information extends beyond the actual recognition of a road user, such as e.g. a pedestrian or cyclist, indicators are searched for in the images which indicate a change of movement of the recognized road user. Indicators of this type are e.g. movements or postures of parts of the body which indicate an expected movement sequence and which relate directly to the continued movement of the road user. This means that indicators are searched for which suggest, with certainty or at least with a very high probability, a prospective movement behavior, since said behavior obeys physical laws. Variable indicators, such as e.g. changes in the center of gravity position, changes in arm or leg movements, changes in head orientations and viewing direction are particularly suitable for predicting spontaneous changes of movement. Taking into account the movement sequence of the motor vehicle, it is furthermore determined whether a collision with a recognized non-motorized road user is probable and, where appropriate, the driver of the motor vehicle is warned.

A method is also known from US 2009/041302 A1. Living beings such as e.g. pedestrians, cyclists and animals in the vicinity of the motor vehicle are recognized and identified on the basis of movement periodicities. Furthermore, the direction of movement of recognized living beings is determined. If a risk of collision is recognized, the driver of the motor vehicle is warned.

US 2006/0187305 A1 discloses a method for recognizing and tracking faces, facial orientations and emotions. It is proposed to observe the driver of a motor vehicle and warn him of his own inattentiveness. It is furthermore proposed to observe the surrounding traffic and warn the driver in precarious situations e.g. concerning pedestrians or obstacles.

US 2010/0185341 A1 discloses a method for recognizing gestures of a person located in or close to a motor vehicle, to which the motor vehicle is intended to react. The method can also recognize threatening gestures of a person located close to a vehicle, e.g. as an attempt at theft, and can, where appropriate, take deterrent measures.

### SUMMARY

The disclosed method and system enables the driver of a motor vehicle to be alerted to the fact that a person (also referred to as a non-motorized road user) intends to inform him of something which he should be aware of and possibly react to. Non-motorized road users normally draw attention to themselves with gestures intended to convey a message to one specific or to all motor vehicle drivers in their vicinity. Thus, for example, a cyclist can indicate an intention to turn off with a hand signal so that following or oncoming motor vehicle drivers can react accordingly.

Motor vehicle drivers who are concentrating on the driving itself easily overlook such messages, particularly in complicated traffic situations or if they are distracted.

According to the disclosed method and system, it is possible for the motor vehicle driver to be alerted merely to the existence of a traffic-related visual message, so that he must check for himself what this message entails, but he is preferably also informed of the content of the recognized message, e.g. visually or audibly, by means of speech synthesis or the like. This means that the message is preferably not only recognized as such, but is also interpreted.

The disclosed method and system improves not only traffic safety, but also the communication of non-motorized road users with motor vehicle drivers in general. The disclosed method and system can thus, for example, make it easier for taxi drivers to become aware of potential customers who are standing at the roadside and are indicating a wish for transportation by means of a hand signal. Or, for example, a traffic policeman can be recognized who is instructing a motor vehicle driver to stop by means of a hand signal. In addition, the disclosed method and system can provide driver assistance systems or vehicle safety systems with useful additional information.

Non-motorized road users are understood here to mean persons who are located on or close to the road (i.e. the carriageway thereof) and in the visual range of the vehicle-mounted camera(s), such as e.g. pedestrians and cyclists, regardless of whether they are currently moving or not. Moreover, only persons whose entire bodies are visible to the camera(s) are to be taken into account in the disclosed method and system. Persons in the immediate vicinity of the motor vehicle, e.g. at a distance of fewer than 10 m, are not to be taken into account, since in such cases an automatic message recognition would be unreliable and would normally be unnecessary. The distance up to which persons are not taken into account can also be modified and/or adapted according to the surrounding conditions or driving situation.

Traffic-related visual messages are understood here primarily to mean specific gestures of persons visible in the camera images which indicate that the person intends to alert the driver of the motor vehicle specifically (and/or any other road users) to something that possibly requires the attention of and/or a response from the driver or other road users.

However, in one preferred example embodiment, traffic-related messages are not only recognized on the basis of gestures, but also further visual indicators are taken into account, in particular type, location, body orientation, head orientation, viewing direction, gestures and/or equipment (i.e. special clothing, head covering and/or objects in the hand) of a gesturing person. If indicators of this type are present in any of a plurality of pre-stored combinations, wherein the type, number and/or strength of the indicators may play a part, this is assumed to involve a message that is relevant to the driver of the motor vehicle.

In each case, traffic-related visual messages are something that someone does entirely intentionally in order to communicate something to one or more other road users, and are therefore distinct from the more or less randomly occurring changes of movement that are not intended to convey a message (such as those observed in the aforementioned prior art).

In one embodiment, only indicators that are essentially static, i.e. do not change so quickly that they would tend to be identified as movements, are taken into account.

In one embodiment, the type, body orientation, head orientation, viewing direction, gestures and/or equipment of a non-motorized road user are recognized through comparison of the latter's outlines with pre-stored patterns.

In one embodiment, if the message conveyed to the motor vehicle driver is one of specific pre-stored traffic-related messages and the motor vehicle driver does not react appropriately to this message, this circumstance is reported to a driver assistance system of the motor vehicle in order to pre-activate it.

In one embodiment, a response to a recognized message consists, in a situation-dependent manner, in a notification or warning of the driver and/or a pre-activation or activation of a driver assistance system.

In a further embodiment, the motor vehicle driver and/or an adaptive algorithm can configure the situations in which a notification, warning or driver assistance is to be provided.

A description of example embodiments follows with reference to the drawings. In the drawings:

### BRIEF DESCRIPTION OF THE DRAWINGS

FIG. 1 shows an overview diagram of a system of a motor vehicle for the automatic recognition of messages of persons in a road environment;

FIGS. 2A-2C show different outlines of possibly relevant road users;

FIG. 3 shows a perspective view of a road environment with non-motorized road users seen from a motor vehicle travelling on the road;

FIGS. 4A-4C show some possible head orientations and viewing directions of a non-motorized road user;

FIGS. 5A-5C show some possible body orientations of a non-motorized road user;

FIGS. 6A-6D show some possible arm positions of a non-motorized road user;

FIG. 7 shows an example of a classification matrix for indicator evaluation for three scenarios involving non-motorized road users; and

FIG. 8 shows a flow diagram of an example of a method for the automatic recognition of non-motorized road users in the vicinity of a traveling motor vehicle on the basis of camera images.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

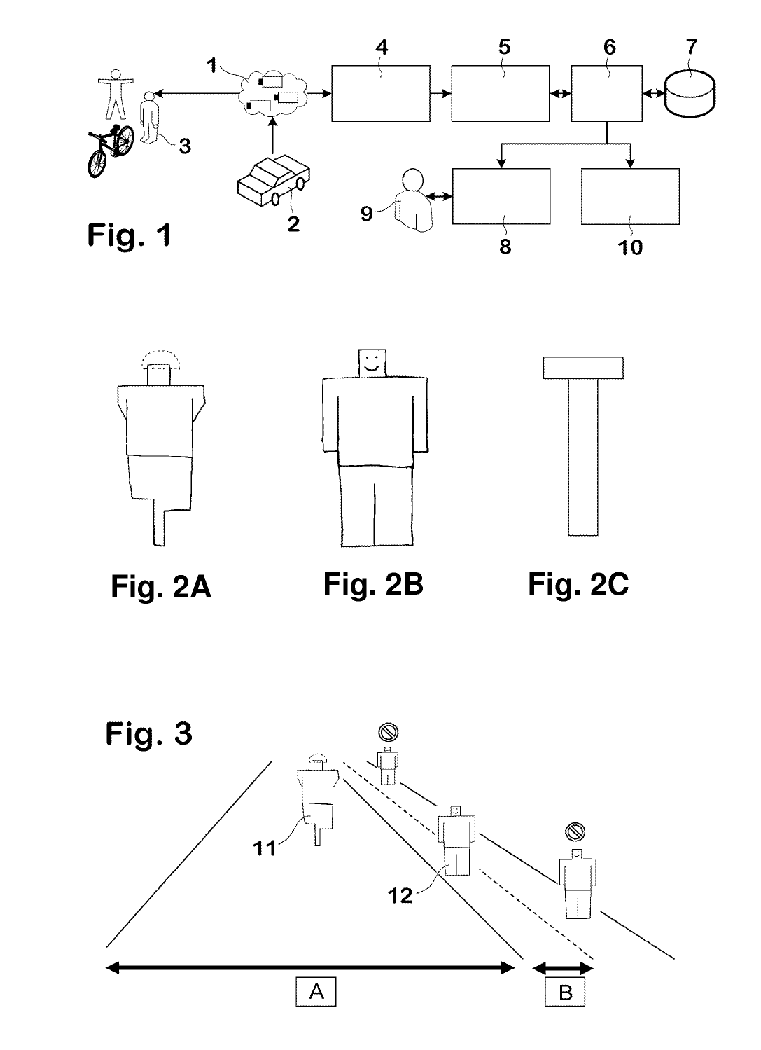

The message recognition system shown in FIG. 1 comprises one or more cameras 1 which are installed in or on a motor vehicle 2 and can visually detect the surroundings of the motor vehicle. In particular, surrounding areas are monitored in which pedestrians, cyclists and other persons who are also referred to herein as non-motorized road users 3 may be located. To do this, at least one camera 1 records images in the direction of travel of the motor vehicle 2.

An image-recording module 4 performs a preprocessing of the recorded images by means of filtering, etc.

An image analysis and feature extraction module 5 first performs a pre-analysis of the preprocessed images in order to determine 1) whether any non-motorized roads users 3 are essentially visible with their entire bodies therein, 2) whether they are located on or close to the road on which the motor vehicle 2 is travelling, 3) whether a road user 3 of this type is performing specific pre-stored gestures or signals, and 4) whether specific gestures or signals apply to the driver 9 of the motor vehicle 2 or are relevant to him (this can be established on the basis of the type and location of the person 3 and the viewing direction and body or arm orientation).

The image analysis and feature extraction module 5 then performs a detailed analysis of the images, if necessary, using further images of the same or a different camera 1 in order to refine the analysis and classify the gestures or signals found by means of the pre-analysis according to their type.

A classification module 6 classifies the gestures or signals found according to relevance. For example, a gesture of a traffic policeman indicating that the driver 9 should stop the motor vehicle is highly relevant, whereas any given greeting person is not. Equipment worn or held by the person gesturing is also taken into account for this classification, such as e.g. special clothing, head covering and/or objects in the hand, such as e.g. a traffic signaling device, such as a sign or paddle.

Historical data and reference data, such as e.g. reference images and classification trees, which are stored in a database 7 can be used in order to facilitate the classification work.

Camera(s) 1 along with components 4-7 described above are preferably software-programmable electronic components of the general type well known in the field of artificial vision, and operate together to form an image recognition system.

A suitable man-machine interface 8 informs the driver 9 of the motor vehicle 2 (for example by means of audible or visual signals) that the driver should pay attention to a gesture of a person 3. If the system has also recognized the meaning of the gesture, e.g. that a hitchhiker wishes to be picked up, the specific meaning of the gesture can also be reported to the driver 9. If the motor vehicle 2 is equipped with augmented reality technology, the person 3 can also be visually highlighted, and the type and/or significance of the gesture can be indicated e.g. by specific colors, wherein e.g. the color red stands for highly significant.

If the motor vehicle 2 is equipped with any given driver assistance systems 10, such as e.g. a lane change assistant or braking assistant, the classification result of the classification module 6 can be used by the driver assistance system 10 to improve and refine decisions and actions.

One example of this is a motor vehicle 2 that approaches a school where a crossing guard is standing on or by the road and is waving a traffic paddle. The message contained therein to drive more slowly and/or stop can be recognized by the message recognition system built into the motor vehicle 1 on the basis of the special clothing of the crossing guard (yellow vest) and the traffic paddle. This significant message is conveyed to the driver 9 of the motor vehicle 2 via the man-machine interface 8. If the driver 9 does not react immediately, a braking assistant is pre-activated and, if the driver still fails to react, the braking assistant can cause the motor vehicle 2 to brake automatically in order to avoid a collision.

Generally speaking, the interpretation of visual messages from persons 3 to the motor vehicle driver 9 takes place in three steps:

The first step is to identify persons 3 who are probably (exceeding a threshold probability level) in the process of visually communicating a message directed at the motor vehicle driver 9.

The second step is to identify and interpret the content of the visual message directed at the motor vehicle driver 9.

The third step is to inform the motor vehicle driver 9 of the message content.

These three steps are explained in more detail below.

Many people are often on the move in an urban environment. Some people possibly wave to someone or gesticulate wildly. In most cases, these gestures or signals do not apply to the motor vehicle driver 9 and can be excluded from the search.

For the search for gestures specifically directed at the motor vehicle driver 9 or the messages contained therein, the images acquired by means of the camera(s) in the motor vehicle 2 are evaluated by means of different image-processing algorithms, as described below.

There are many methods in the prior art for recognizing persons or other living beings in images containing a multiplicity of objects. In the context of the disclosed method and system, it is proposed to classify non-motorized road users into four groups according to their type: stationary or walking pedestrians, cyclists, horse riders and others.

However, whether a road user of this type is at all relevant to the motor vehicle driver 9 depends on his direction of movement and orientation in relation to the motor vehicle 2. Seen from the motor vehicle 2, a cyclist riding ahead normally has an outline as shown in FIG. 2A. Seen from the motor vehicle 2, a stationary person facing toward the motor vehicle 2 normally has an outline as shown in FIG. 2B. An outline as shown, for example, in FIG. 2C would be identified as another road user.

Whether a road user of this type is at all relevant to a motor vehicle driver 9 furthermore depends on his/its position in a road environment (as generally depicted in FIG. 3), e.g. on or near the road. As shown in FIG. 3, only persons in the road environment who are located either on the carriageway A in FIG. 3 or on a narrow strip B adjoining the carriageway A to the right in FIG. 3 are taken into account in the context of the disclosed method. The strips A and B can be differentiated e.g. on the basis of curb edges. In FIG. 3, a cyclist 11 is riding in the strip A in front of the motor vehicle 2 and a pedestrian 12 is standing in the strip B. Persons further away from the carriageway A are not taken into account, as shown.

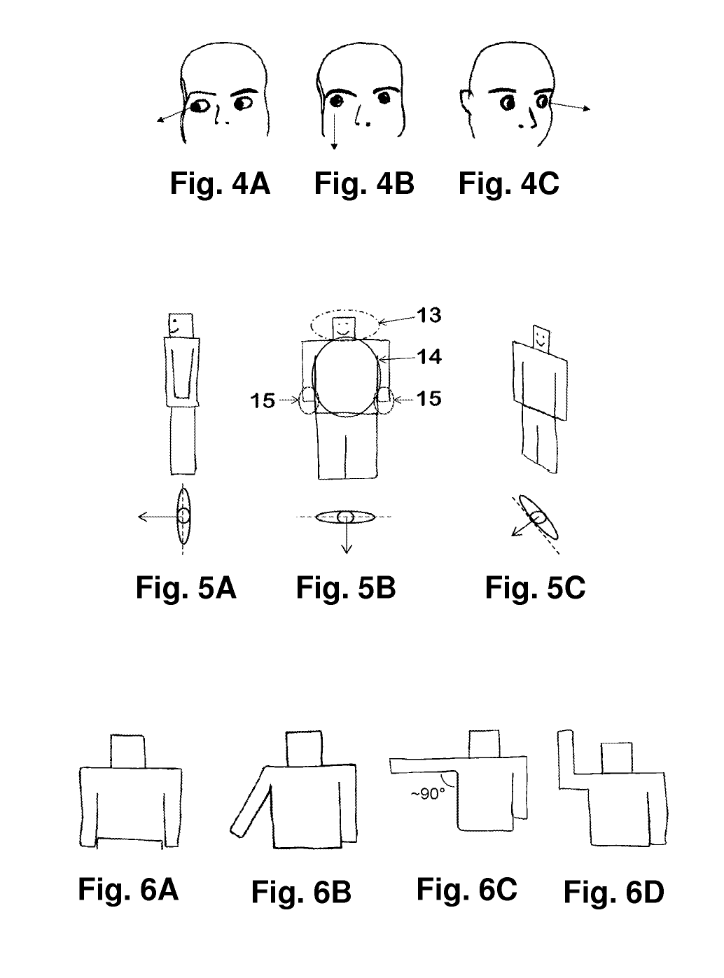

The cyclist 11 seen from behind in FIG. 3 is in any case relevant. The extent to which the pedestrian 12 is relevant depends on his body orientation, head orientation and viewing direction. FIGS. 4A to 4C show different head orientations and viewing directions of a person in relation to a motor vehicle 2 from which the person is filmed. As can be seen, only the person shown in FIG. 4B, in whose case both the head orientation and viewing direction point toward the motor vehicle 2, is obviously paying attention to the motor vehicle 2.

FIGS. 5A-5C show different possible body orientations and viewing directions of a pedestrian in relation to the motor vehicle 2, i.e. in FIG. 5A a pedestrian oriented sideways in relation to the motor vehicle 2, in FIG. 5B a pedestrian oriented frontally toward the motor vehicle 2 and in FIG. 5C a pedestrian oriented partially toward the motor vehicle 2. In the case of the pedestrian shown in FIG. 5B, it is most probable that he wishes to communicate with the motor vehicle driver 9. In order to extract pedestrians with potential messages to the motor vehicle driver 9, a plane through the shoulders of each pedestrian is generated in each case, said planes being plotted below the pedestrian outlines in FIGS. 5A-5C as broken lines. A vector is then generated in each case which is perpendicular to the respective shoulder plane and passes through the vertical axis of symmetry of the pedestrian, as plotted as an arrow below the pedestrian outlines in FIGS. 5A-5C. It is then determined whether or not this vector points toward the motor vehicle 2. If so, the pedestrian is oriented toward the motor vehicle 2 and possibly intends to communicate with the motor vehicle driver 9. This intent to communicate is assessed to be relatively more probable in the case of the pedestrian shown in FIG. 5B and somewhat less probable for the pedestrian shown in FIG. 5C.

An indicator evaluation is then carried out, wherein the indications acquired from the camera images that a person may be classified as a message provider are considered in combination with one another. To do this, a search is carried out according to predefined feature combinations of type, location and orientation of the person. A suitable training algorithm, e.g. in the form of a neural network, could improve the decision logic for uncertain or inconclusive situations. Some indicators can be more strongly weighted than others. For example, pedestrians on the road can be more strongly weighted than pedestrians on the sidewalk.

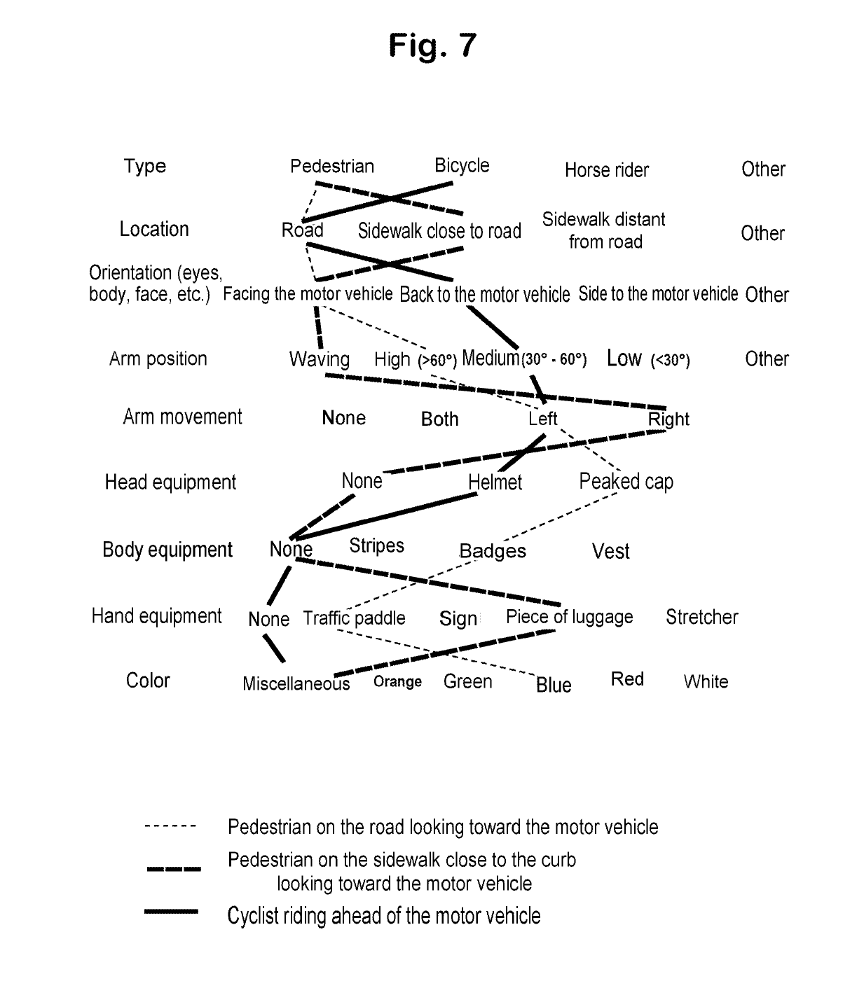

FIG. 7 shows an example of a classification matrix for indicator evaluation for three scenarios involving persons who are relevant to the message recognition system and can be taken into account as message providers because they possibly wish to communicate something visually to the motor vehicle driver 9.

In FIG. 7, thin, short broken lines represent a pedestrian who is located on the road and is looking in the direction of the motor vehicle 2. Thick, long broken lines represent a pedestrian on the sidewalk close to the curb and with a viewing direction toward the motor vehicle 2, similar to the pedestrian 12 in FIG. 3. Thick, unbroken lines represent a cyclist riding ahead on the road, such as the cyclist 11 in FIG. 3.

In the example of a classification matrix shown in FIG. 7, the lines in the first three rows are used for the aforementioned step of identifying persons who presumably currently intend to communicate a message to the motor vehicle driver 9. Areas in FIG. 7 in which no lines of this type run can be ignored. Feature combinations in the areas traversed by lines are compared with pre-stored feature combinations in order to determine the indicator strength of these feature combinations, wherein the individual features can be weighted differently to evaluate a probability that a particular person is directing a visual message at the vehicle driver 9.

The further rows and plotted lines in the classification matrix shown in FIG. 7 are used to identify and interpret visual messages to the motor vehicle driver 9.

Arm positions, some of which are illustrated in FIGS. 6A-6D for a pedestrian as seen in FIG. 5B, i.e. both arms hanging (FIG. 6A), one arm slightly raised, i.e. up to 30° (FIG. 6B), one arm raised to medium height, i.e. 30° to 60°, one arm raised high, i.e. more than 60° (FIG. 6C), and one arm raised into the air, i.e. waving (FIG. 6D) are first used for the identification and interpretation.

Whether the left or right arm of the non-motorized road user is moving is also taken into account for the identification and interpretation. For example, a cyclist riding ahead or oncoming with an outstretched left arm may be interpreted to indicate that he intends to turn off to the left and that following or oncoming vehicles should take this into account.

Specific head equipment, such as e.g. helmets or peaked caps, is furthermore taken into account for the identification and interpretation, for which purpose the image analysis concentrates on the head area 13 indicated in FIG. 5B.

Specific body equipment, such as e.g. stripes, badges or specific words such as e.g. “Police”, is furthermore taken into account for the identification and interpretation, for which purpose the image analysis concentrates on the core area 14 indicated in FIG. 5B.

Specific hand-held equipment, such as e.g. a traffic paddle, a sign with a town name, a piece of luggage, a stretcher, etc., is furthermore taken into account for the identification and interpretation of visual messages, for which purpose the image analysis concentrates on the hand areas indicated in FIG. 5B.

Colors and color patterns such as those characteristic of the uniforms of traffic policemen, firemen, road workers, etc., can also be taken into account for the identification and interpretation, possibly also depending on the vehicle location, since such colors and color patterns are country-specific.

If all these indicators are connected by lines, as shown in FIG. 7, this produces a vector sequence of feature combinations which is compared with pre-stored feature combinations. Since specific features are often associated with one another, e.g. a traffic policeman wears typical clothing and head covering or a cyclist often wears a helmet, this reliably indicates whether a person is conveying a message directed at the motor vehicle driver 9 and what that message is.

The vector sequence represented in FIG. 7 by thin, short broken lines indicates a pedestrian who is located on the road and is looking in the direction of the motor vehicle 9, is raising his right arm, holding a traffic paddle in his hand and wearing a peaked cap and blue clothing. Taken all together, these are relatively reliable indicators that a traffic policeman is currently instructing the motor vehicle driver 9 to stop.

The vector sequence represented in FIG. 7 by thick, long broken lines indicates a pedestrian who is located on the sidewalk close to the curb and is looking toward the motor vehicle 9, is waving his right hand and is perhaps carrying a piece of luggage. This means that this is a potential customer for a taxi driver.

The vector sequence represented by thick unbroken lines in FIG. 7 indicates a cyclist riding ahead who is extending his left arm horizontally and is wearing a helmet. This means that this cyclist intends to turn off to the left and is presumably about to cross the path of the motor vehicle 2.

Many feature combinations are possible for each class of messages, and not all possible features must necessarily be present for some classes. It is thus possible to determine some classes of messages on the basis of only a few features. The time which the classification algorithm requires and the required processing power can thereby be reduced.

The mandatory and optional features for the three classes of messages represented by lines in FIG. 7 are listed in the following table:

TABLE 1

| Class | | | | Arm | Arm | Head | Body | Hand | |
|---|---|---|---|---|---|---|---|---|---|
| (message) | Type | Location | Orientation | position | mvmt. | equip. | equip. | equip. | Color |
| Bicycle | Bicycle | Road/ | Back to | Medium/ | Left | Any | Any | Any | Any |
| turning | | close to | vehicle/ | High/ | | | | | |
| left | | road | Facing | Waving | | | | | |
| | | | vehicle | | | | | | |
| | Mandatory | | | | | Optional | | | |
| Taxi | Pedestrian | Close to | Facing | Medium/ | Left/ | Any | Any | Any | Any |
| customer | | road | vehicle | High/ | Right/ | | | | |
| | | | | Waving | Both | | | | |
| | Mandatory | | | | | Optional | | | |
| Traffic | Pedestrian | Close to | Facing | Medium/ | Left/ | Helmet/ | Badge/ | Traffic | Any |
| policeman | | road/ | vehicle | High/ | Right/ | Peaked | Uniform | paddle/ | |
| | | Road | | Waving | Both | cap | | Nothing | |

Mandatory

Further possible scenarios would be e.g.: A pedestrian on the road with no particular arm movement who is wearing a helmet and red clothing and is furthermore holding a tubular object in his hand is presumably a fireman who per se conveys a message to take care.

A pedestrian on the road who is waving one arm and is wearing a helmet and striped orange clothing, is presumably a road worker who is signaling to the motor vehicle driver 9 to stop or take evasive action.

A pedestrian close to the road who is raising one arm slightly and is holding a sign in his hand on which a town name is written is presumably a hitchhiker, particularly if a piece of luggage is located close by.

A pedestrian on the road with no particular arm movement who is wearing white clothing and is not alone is possibly a paramedic, particularly if a stretcher is close by.

Scenarios that are inconsistent and do not enable unambiguous interpretation will either not be taken into account by the message recognition system, or further analyses will be carried out, for example as follows:

Are any particular objects (e.g. broken down motor vehicle, warning triangle, etc.) located in the vicinity of the gesticulating person?

Is the person moving or not?

Is the person moving toward the vehicle or away from it?

How quickly is the person moving?

Does an external microphone of the motor vehicle pick up any particular noises (e.g. whistle, pneumatic drill, etc.)?

Are flashing lights visible?

Is the person interacting with further persons on the carriageway (e.g. a crossing guard)?

Facial recognition: Is the person someone known to the driver who merely intends to greet him?

Depending on the identified message, the system can inform the driver in different ways. For example, there may be three different ways of reacting:

1. Notification: The driver receives an audible and/or visual notification that a specific message has been recognized. The driver can be informed of the existence of the message or content, i.e. who is conveying what message and why and the like. For example, the driver receives the notification that a hitchhiker wishes to be picked up, or a taxi driver receives an indication of a potential customer.

2. Warning: The driver receives a particularly clear and/or urgent audible or visual notification that a specific message has been recognized which requires an action of the driver in response. For example, the driver receives the notification that a road worker is asking him to drive slowly or that a traffic policeman is instructing him to stop.

3. Driver assistance: If the driver does not react to a warning (due to driver distraction, for example), a driver assistance system is pre-activated. In such a case, for example, a braking assistant could apply the brake pads more closely to the discs. Or, in the case of the recognition of a cyclist who is turning off, an overtaking manoeuver of the driver could be compulsorily delayed.

The situations in which a notification, warning or driver assistance is given may be configurable by the driver. Additionally or alternatively, a configuration of this type can be supplemented or refined by an adaptive algorithm which observes and analyses driver responses to any given messages over a considerable period of time. An algorithm of this type may also supplement classes of situations with situations in which it has identified a similar driver behavior, or may create new classes of situations or modify default ways of reacting according to the identified driver behavior.

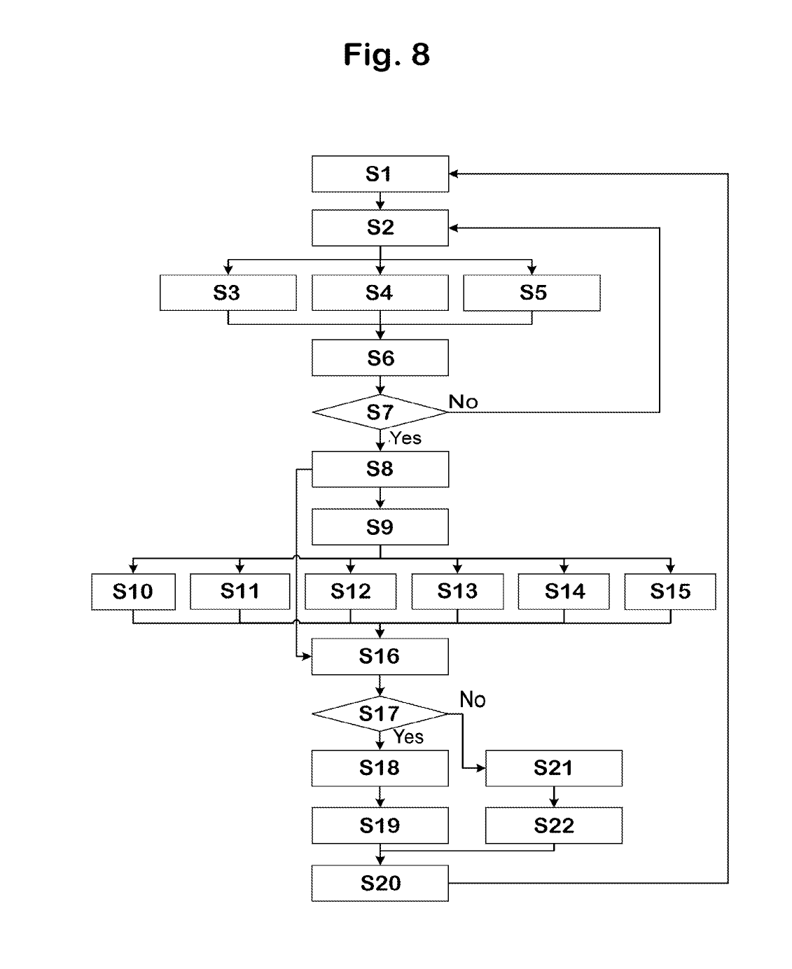

In the example of a message recognition method shown in FIG. 8, video images are read in from one or more cameras in step S1. In step S2, persons are extracted from the images on the basis of their outlines. In the parallel steps S3, S4 and S5, the type, location and orientation of the recognized road users are determined from the contours and the road users are classified on this basis in step S6. In step S7, it is determined whether one of the road users is considered as a message provider [relative to the vehicle/driver]. If not, the method returns to step S2, and if so, the features of said road user are stored in step S8 and a possible message is determined therefrom in step S9. In steps S10 to S15, parallel analyses of arm positions, arm movements, head equipment, hand equipment, body equipment and color patterns of the person who has been identified as a message provider are carried out, and the message is classified in step S16. In step S17, it is determined whether everything is conclusive. If so, the manner in which the driver is to be informed is defined in step S18, the driver is informed of the recognized message in step S19, and, in step S20, the method returns to step S1. If it is determined in step S17 that not everything is conclusive, the reaction of the driver is observed in step S21 and the classification and interpretation methods are supplemented or modified in step S22 in accordance with the driver's reaction.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1-9. (canceled)

10. A method of operating an image recognition system of a motor vehicle comprising:
analyzing images from a camera relative to a first criteria set to evaluate a probability that a person is directing a visual message at a driver of the vehicle;
if the probability exceeds a threshold value, analyzing the images relative to a second criteria set to interpret a content of the message; and
notifying the driver of the content.

11. The method of claim 10, wherein the first criteria set comprises at least one of a location of the person in a road environment, a viewing direction, a head orientation, and a body orientation.

12. The method of claim 10, wherein the second criteria set comprises at least one of an arm position of the person and equipment associated with the person.

13. The method of claim 10, wherein analysis of the image relative to at least one of the first and the second criteria sets comprises comparison of the image with pre-stored patterns.

14. The method of claim 10, further comprising:
activating a driver assistance system of the motor vehicle if the message matches a pre-stored traffic-related.

15. The method of claim 14, wherein the driver assistance system is activated only if a driver reaction appropriate to the message is not detected within a time limit after the driver is notified.

16. The method of claim 10, further comprising modifying a method used to interpret the content based upon an observed driver reaction to the message.

17. A method of operating an image recognition system of a motor vehicle comprising:
analyzing images from a camera relative to a first criteria set to determine that a person is directing a visual message at a driver of the vehicle;
only if the message is directed at the driver, analyzing the images relative to a second criteria set to interpret a content of the message; and
notifying the driver of the content.

18. The method of claim 17, wherein the first criteria set comprises at least one of a location of the person in a road environment, a viewing direction, a head orientation, and a body orientation.

19. The method of claim 17, wherein the second criteria set comprises at least one of an arm position of the person and equipment associated with the person.

20. The method of claim 17, wherein analysis of the image relative to at least one of the first and the second criteria sets comprises comparison of the image with pre-stored patterns.

21. The method of claim 17, further comprising:
activating a driver assistance system of the motor vehicle if the message matches a pre-stored traffic-related.

22. The method of claim 21, wherein the driver assistance system is activated only if a driver reaction appropriate to the message is not detected within a time limit after the driver is notified.

23. The method of claim 17, further comprising modifying a method used to interpret the content based upon an observed driver reaction to the message.

24. A method of operating an image recognition system of a motor vehicle comprising:
analyzing images from a camera relative to a first criteria set to determine that a person is directing a visual message at a driver of the vehicle;
only if the message is directed at the driver, analyzing the images relative to a second criteria set to interpret a content of the message;
notifying the driver of the content; and
activating a driver assistance system of the motor vehicle if the message matches a pre-stored traffic-related and a driver reaction appropriate to the message is not detected within a time limit.

25. The method of claim 24, wherein the first criteria set comprises at least one of a location of the person in a road environment, a viewing direction, a head orientation, and a body orientation.

26. The method of claim 25, wherein the body orientation is evaluated by generating a vector perpendicular to a shoulder plane of the person, and determining whether the vector points toward the vehicle.

27. The method of claim 24, wherein the second criteria set comprises at least one of an arm position of the person and equipment associated with the person.

28. The method of claim 24, wherein the analysis of the image relative to at least one of the first and the second criteria sets comprises comparison of the image with pre-stored patterns.

29. The method of claim 24, further comprising modifying a method used to interpret the content based upon an observed driver reaction to the message.
